(19) United States
(12) Patent Application Publication
(10) Pub. No.: US 2006/0114790 A1
(43) Pub. Date: Jun. 1, 2006

(54) Fabrication of digital media using masking and electron or ion exposure technology

(76) Inventors: Charles Marshall, Burbank, CA (US); John A. Trepl II, Dana Point, CA (US); Roger A. Kuntz, Laguna Niguel, CA (US); Axel M. Kuntz, Lake Forest, CA (US)

Correspondence Address: Zilka-Kotab, PC, P.O. BOX 721120, SAN JOSE, CA, 95172-1120, US

(21) Appl. No.: 11/001,196

(22) Filed: Nov. 30, 2004

(51) Int. Cl. G11B 7/00

(52) U.S. Cl. 369/100; 369/126

(57) ABSTRACT

A system and method for writing data to an optical medium includes positioning a mask over a medium, and directing electrons or ions from an electron or ion source at the mask, the electrons or ions passing through apertures in the mask and onto the optical medium for creating surface features on the optical medium, the surface features representing data

### FIELD OF THE INVENTION

The present invention relates to digital media manufacturing and more particularly, this invention relates to manufacturing digital media using electron or ion beam technology and a mask defining surface features that represent data.

### BACKGROUND OF THE INVENTION

Optical media presently include compact discs (CDs), digital video discs (DVDs), laser discs, and specialty items. Optical media has found great success as a medium for storing music, video and data due to its durability, long life, and low cost.

A CD typically comprises an underlayer of clear polycarbonate plastic. During manufacturing, the polycarbonate is injection molded against a master having protrusions (or pits) in a defined pattern that creates an impression of microscopic bumps arranged as a single, continuous, spiral track of data on the polycarbonate. Then, a thin, reflective aluminum layer is sputtered onto the disc, covering the bumps. Next a thin acrylic layer is sprayed over the aluminum to protect it. A label is then printed onto the acrylic. FIG. 1 illustrates a cross section of a typical data or audio CD 100, particularly depicting the polycarbonate layer 102, aluminum layer 104, acrylic layer 106, label 108, and pits 110 and lands 112 that represent the data stored on the CD 100. Note that the “pits” 110 are as viewed from the aluminum side, but on the side the laser reads from, they are bumps. The elongated bumps that make up the data track are each 0.5 microns wide, a minimum of 0.83 microns long and 125 nanometers high. The dimensions of a standard CD is about 1.2 millimeters thick and about 4.5 inches in diameter. A CD can hold about 740 MB of data.

During playback, the reader's laser beam passes through the polycarbonate layer, reflects off the aluminum layer and hits an opto-electronic device that detects changes in light. The bumps reflect light differently than the lands, and an opto-electronic sensor detects that change in reflectivity. The electronics in the reader interpret the changes in reflectivity in order to read the bits that make up the data.

The data stored on the CD is retrieved by a CD player that focuses a laser on the track of bumps. The laser beam passes through the polycarbonate layer, reflects off the aluminum layer and hits an opto-electronic device that detects changes in light. The bumps reflect light differently than the lands, and the opto-electronic sensor detects that change in reflectivity. The electronics in the drive interpret the changes in reflectivity in order to read the bits that make up the bytes.

A DVD is very similar to a CD, and is created and read in generally the same way (save for multilayer DVDs, as described below). However, a standard DVD holds about seven times more data than a CD.

Single-sided, single-layer DVDs can store about seven times more data than CDs. A large part of this increase comes from the pits and tracks being smaller on DVDs. Table 1 illustrates a comparison of CD and DVD specifications.

TABLE 1

| Specification | CD | DVD |
|---|---|---|
| Track Pitch | 1600 nanometers | 740 nanometers |
| Minimum Pit Length (single-layer | 830 nanometers | 400 nanometers |
| DVD) | | |
| Minimum Pit Length (double-layer | 830 nanometers | 440 nanometers |
| DVD) | | |

To increase the storage capacity even more, a DVD can have up to four layers, two on each side. The laser that reads the disc can actually focus on the second layer through the first layer. Table 2 lists the capacities of different forms of DVDs.

TABLE 2

| Format | Capacity | Approx. Movie Time | |
|---|---|---|---|
| Single-sided/single-layer | 4.38 GB | 2 | hours |
| Single-sided/double-layer | 7.95 GB | 4 | hours |
| Double-sided/single-layer | 8.75 GB | 4.5 | hours |
| Double-sided/double-layer | 15.9 GB | Over 8 | hours |

A DVD is composed of several layers of plastic, totaling about 1.2 millimeters thick. FIG. 2 depicts the cross section of a single sided/double-layer DVD 200. Each layer is created by injection molding polycarbonate plastic against a master, as described above. This process forms a disc 200 that has microscopic bumps arranged as a single, continuous and extremely long spiral track of data. Once the clear pieces of polycarbonate 202, 204 are formed, a thin reflective layer is sputtered onto the disc, covering the bumps. Aluminum 206 is used behind the inner layers, but a semi-reflective gold layer 208 is used for the outer layers, allowing the laser to focus through the outer and onto the inner layers. After all of the layers are made, each one is coated with lacquer, squeezed together and cured under infrared light. For single-sided discs, the label is silk-screened onto the nonreadable side. Double-sided discs are printed only on the nonreadable area near the hole in the middle. Cross sections of the various types of completed DVDs (not to scale) look like this

A DVD player functions similarly to the CD player described above. However, in a DVD player, the laser can focus either on the semi-transparent reflective material behind the closest layer, or, in the case of a double-layer disc, through this layer and onto the reflective material behind the inner layer. The laser beam passes through the polycarbonate layer, bounces off the reflective layer behind it and hits an opto-electronic device, which detects changes in light.

One problem with each of these technologies is that it is very expensive and time consuming to create the master. Another problem is that if the master is not perfectly formed, none of the discs created from it will work properly. Further, as shown in FIG. 3A, the bumps 302 on the master 300 must be beveled so that the polycarbonate 304 releases from the master 300. This beveling places limits on the size of the surface features, as reading ability is reduced as the amount of beveling moves from 90 degrees.

Another problem is that the ends 306 of the bumps 302 of the master are also rounded, as shown in FIG. 3B, to aid in separation of the master 300 from the polycarbonate 304. However, the rounded edge causes jitter during the playback. In fact, >50% of jitter can be attributed to the rounded edges.

CDs and DVDs also come in the form of recordable discs. CD-recordable discs (CD-Rs) and DVD-recordable discs (DVD±Rs), do not have any bumps or flat areas (pits or lands). Instead, as shown on the cross section of a recordable disc 400 in FIG. 4, they have a smooth reflective metal layer 402, which rests on top of a layer of photosensitive dye 404, a layer of polycarbonate 406 under the dye, and a backing layer 408. When the disc is blank, the dye is translucent: light can shine through and reflect off the metal surface. The write laser darkens the spots 410 where the bumps would be in a conventional CD or DVD, forming non-reflecting areas. This is known as “burning” a disc. By selectively darkening particular points 410 along the data track, and leaving other areas of dye translucent, a digital pattern is created that is readable by a standard CD or DVD player. The light from the player's laser beam will only bounce back to the sensor when the dye is left translucent, in the same way that it will only bounce back from the flat areas of a conventional CD or DVD.

In place of the CD-R and DVD-R disc's dye-based recording layer, CD-RW and DVD+RW use a crystalline compound made up of a mix of silver, indium, antimony and tellurium. When this combination of materials is heated to one temperature and cooled it becomes crystalline, but if it is heated to a higher temperature, when it cools down again it becomes amorphous. The crystalline areas allow the reflective layer to reflect the laser better while the non-crystalline portion absorbs the laser beam, so it is not reflected.

In order to achieve these effects in the recording layer, the disc recorder use three different laser powers: the highest laser power, which is called “Write Power”, creates a non-crystalline (absorptive) state on the recording layer; the middle power, also known as “Erase Power”, melts the recording layer and converts it to a reflective crystalline state; the lowest power, which is “Read Power”, does not alter the state of the recording layer, so it can be used for reading the data.

During writing, a focused “Write Power” laser beam selectively heats areas of the phase-change material above the melting temperature (500-700° C.), so all the atoms in this area can move rapidly in the liquid state. Then, if cooled sufficiently quickly, the random liquid state is “frozen-in” and the so-called amorphous state is obtained. The amorphous version of the material shrinks, leaving a pit where the laser dot was written, resulting in a recognizable CD or DVD surface. When an “Erase Power” laser beam heats the phase-change layer to below the melting temperature but above the crystallization temperature (200° C.) for a sufficient time (at least longer than the minimum crystallization time), the atoms revert back to an ordered state (i.e., the crystalline state). Writing takes place in a single pass of the focused laser beam; this is sometimes referred to as “direct overwriting” and the process can be repeated several thousand times per disc.

One problem with recordable optical media is that burning takes a long time, making replication of discs by this method very inefficient. For example, it takes over 2 minutes to burn a 640 MB CD-R at 48× normal read speed. It takes 14-16 minutes to burn a single side, single layer DVD±R. These times do not include the other processing time, such as the time it takes to open the drive door, load the disc, close the door, initiate the drive, then after burning open the door, remove the disc, etc.

Another problem with recordable media is that the writing laser inherently produces dye spots with rounded edges. As mentioned above, rounded edges create jitter.

What is therefore needed is a way to improve the write speed for optical media.

What is also needed is a way to create near-90 degree transitions between bumps and lands so that the data density along the data track can be increased.

What is further needed is a way to write media in a way that the surface features have near-straight edges.

### SUMMARY OF THE INVENTION

To overcome the aforementioned drawbacks and provide the desirable advantages, a method for writing data to an optical medium includes positioning a mask over a medium, and directing electrons or ions from an electron or ion source at the mask, the electrons or ions passing through apertures in the mask and onto the optical medium for creating surface features on the optical medium, the surface features representing data.

A system for performing this method, according to one embodiment, includes a medium receiving portion for holding an optical medium, an electron or ion source such as an electron or ion gun for emitting a beam of electrons or ions at the optical medium on the medium receiving portion, and a mask having apertures therein. The electrons or ions pass through the apertures in the mask and strike the optical medium for creating surface features on the optical medium, the surface features representing data.

The system described herein can write data such as audio data, video data, software, etc. to an optical medium very quickly, e.g., in less than one minute, and even in less than one second. The system is able to write data to any type of optical media, including those readable by consumer-grade CD and DVD players. Suitable optical media include any type of commercially available medium, including CD, DVD, laser disc, recordable discs (e.g., CD-R, CD-RW, DVD+R, DVD-R, DVD+RW, DVD-RW), or any type of medium from which data is read optically.

If the optical medium is a disc, the pattern preferably has a generally spiral shape. In one embodiment, the medium comprises a substantially transparent layer and a reflective layer, the electrons or ions damaging the reflective layer. In another embodiment, the medium comprises a substantially transparent layer and a reflective layer, the electrons or ions creating pits in the substantially transparent layer, the reflective layer being added after the surface features are created. In a further embodiment, the medium comprises a reflective layer, and a dye layer being substantially transparent in an unexposed state, the electrons or ions creating darkened portions of the dye layer. In yet another embodiment, the surface features are created on at least two layers of the optical medium, as in a double layer DVD.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a partial cross sectional view, not to scale, of a CD.

FIG. 2 is a partial cross sectional view, not to scale, of a single sided, dual-layer DVD.

FIG. 3A is a partial cross sectional view, not to scale, of a master and polycarbonate layer.

FIG. 3B is a partial cross sectional view, not to scale, taken along line 3B-3B of FIG. 3A.

FIG. 4 is a partial cross sectional view, not to scale, of a recordable medium.

FIG. 5 is a representative system diagram of a system for writing data to an optical medium according to one embodiment.

FIG. 6 is a perspective view of a mask used when writing data to a medium.

FIG. 7 is a detailed view taken from Circle 7 of FIG. 6.

FIG. 8A is a detailed view taken along line 8-8 of FIG. 7.

FIG. 8B is a variation of FIG. 8A.

FIG. 9 is a detailed view taken from Circle 9 of FIG. 8.

FIG. 10 is a side view of a surface feature created by an electron or ion beam.

FIG. 11 is a flow diagram of a method for creating a mask according to an illustrative embodiment.

FIG. 12 is a flow diagram of a method for writing data to a medium according to an illustrative embodiment.

FIG. 13 is a flow diagram of a method for writing data to a single sided, double layer (per side) DVD according to an illustrative embodiment.

FIG. 14 is a flow diagram of a method for writing data to a recordable disc, such as a commercially available recordable CD or DVD according to an illustrative embodiment.

FIG. 15 is a flow diagram of a method for writing data to a recordable disc, such as a commercially available recordable CD or DVD according to another illustrative embodiment.

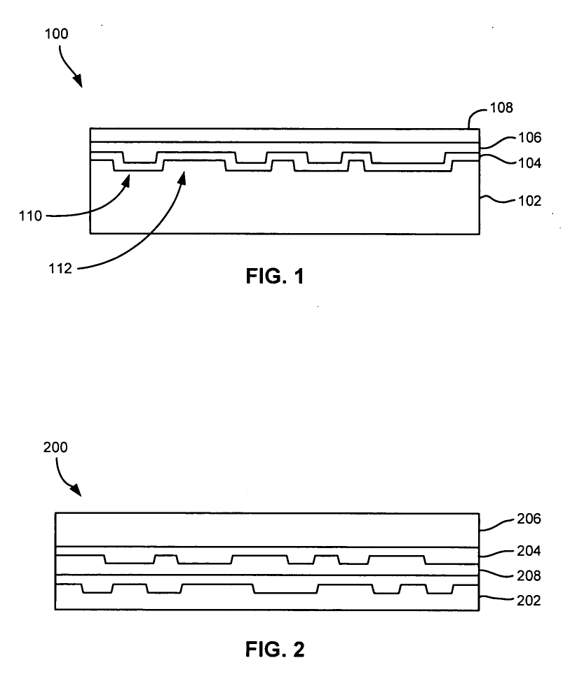

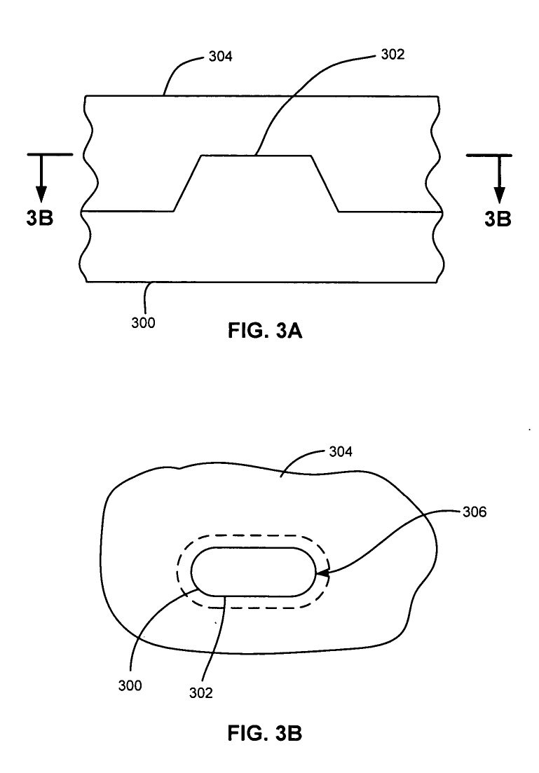

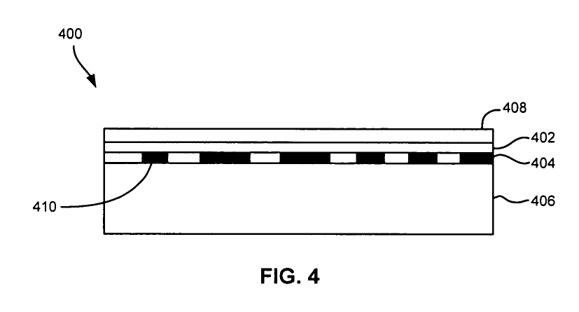

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The present invention enables creation of media using a mask to define surface features representing data, and ion or electron exposure to create the surface features defined by the mask.

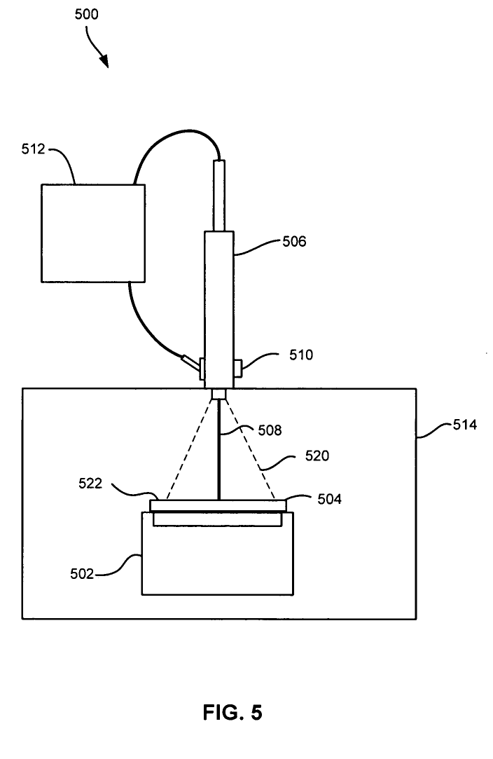

FIG. 5 illustrates a system 500 for writing data to an optical medium according to one embodiment. The system 500 includes a medium receiving portion 502 for holding a target optical medium 504, and an electron or ion source 506 such as an electron or ion gun for emitting a beam 508 or flood 520 of electrons or ions at the optical medium on the medium receiving portion 502. A controller 512 controls operation of the system components. An optional steering mechanism 510, which may be integral with the gun 506, can be provided to directing the electron or ion beam 508 onto the optical medium 504 in a controlled manner such as in a spiral, concentric circles, straight lines, etc. The beam 508 of electrons or ions may be diffuse, or may be focused, depending on the desired operating parameters.

A electron or ion mill-resistant mask 522 is placed over the medium 504. The mask 522 has apertures therethrough in a data track pattern representing the desired pit structure to be transferred to the optical medium 504.

The beam 508 or flood 520 of electrons or ions is directed at the mask 522. If a diffuse beam is being used, for instance, the steering mechanism 510 can be used to sweep the beam 508 across the medium 504. The steering mechanism 510 can also be used in conjunction with a beam blanker (not shown) to sequentially bombard different sections of the mask 522 and medium 504. Some electrons or ions pass through the apertures of the mask 522 and bombard the optical medium 504 in the data track pattern, thereby creating surface features on the optical medium 504. Particularly, the electrons or ions displace or oblate the material they strike, creating pits. The resultant pits and lands along the data track represent data. At least the medium receiving portion 502 should be positioned in a vacuum chamber 514 maintained at a vacuum of 1×10⁻³ Torr or below. Note that the emitting portion of the gun 506 should also be positioned in the vacuum chamber 514.

The mask 522, which will be described in more detail below, can be reused to create many copies of the media. And because commercially available media is formed of relatively soft materials (e.g., polycarbonate and aluminum), the electron or ion source 506 can be operated at a lower power, thereby reducing the wear on the mask.

Accordingly, standard electron or ion beam lithography machine sinter technology can be combined with reusable masking technology to write an image pattern to target media, thereby combining the fine feature size detail of electron or ion beam lithography with the imaging speed of masking.

The system described herein can write data such as audio data, video data, software, etc. to an optical medium very quickly, e.g., in less than one minute, and even in less than one second. The system is able to write data to any type of optical media of any material, and would extend to future types of optical media that are presently under development or have yet to be discovered.

Electron guns have been widely used in the semiconductor industry to define electronic components with features down to about 5 nanometers. Such guns are suitable for use in the present invention. In general, an electron gun includes a small heater that heats a cathode. When heated, the cathode emits a cloud of electrons. Two anodes turn the cloud into an electron beam. An accelerating anode attracts the electrons and accelerates them toward the target (here, an optical medium) at a very high speed. A focusing anode, e.g., deflection plates and Einzel lens, focuses the stream of electrons into a very fine beam. By adjusting the power to the accelerating anode, the speed of the electrons, and thus their energy, can be set to create the desired depth of the pits being created on the medium. By adjusting the power to the heater, the number of electrons emitted can be controlled, which in turn affects the depth and width of the pits.

Many cathode types and sizes are available: tantalum disc cathodes, tungsten hairpins, single-crystal lanthanum hexaboride (LaB₆) cathodes, barium oxide (BaO) cathodes, or thoria-coated (ThO₂) iridium cathodes. UHV technology is preferably used throughout. The guns can be run in vacuums from 10⁻¹¹ torr up to 10⁻⁵ torr for the various refractory metal cathodes. A minimum vacuum recommended for LaB₆ or BaO cathodes is roughly 1×10⁻⁷ torr. Thoria cathodes can be run up to 10⁻⁴ torr and above

Suitable electron guns include the EGG-3101, EGPS-3101, EMG-12, and EGPS-12 available from Kimball Physics, 311 Kimball Hill Road, Wilton, N.H. 03086-9742 USA. One skilled in the art will recognize that there are several manufacturers of electron guns that are also suitable for use with the system, including those having larger and smaller spot sizes.

Where ion beam technology is used, the system of the present invention can incorporate therein a positive ion source or a negative ion source. Illustrative ion species which perform the bombardment are Ar+, O₂+, Ga+, Cs+, Li+, Na+, K+, Rb+, etc.

A preferred embodiment implements a Focused Ion Beam (FIB) system. A FIB system takes charged particles from a source, focuses them into a beam through electromagnetic/electrostatic lenses, and then scans across small areas of the target using deflection plates or scan coils. The FIB system produces high resolution imaging by collecting the secondary electron emission produced by the beam's interaction with the target surface. Contrast is formed by raised areas of the sample (hills) producing more secondary electrons than depressed areas (valleys).

In a preferred embodiment, the FIB system uses gallium ions from a field emission liquid metal ion (FE-LMI) source. In operation, a gallium (Ga⁺) primary ion beam hits the sample surface and sputters a small amount of material, the displaced material leaving the surface as either secondary ions (i⁺ or i⁻) or neutral atoms (n⁰). The primary ion beam also produces secondary electrons (e-). As the primary beam rasters on the sample surface, the signal from the sputtered ions or secondary electrons is collected to form an image.

At low primary beam currents, very little material is sputtered; modern FIB systems can achieve 5 nm imaging resolution. At higher primary currents, a great deal of material can be removed by sputtering, allowing precision milling of the specimen down to a sub-micron scale.

Many variables and material properties affect the sputtering rate of a sample. These include beam current, sample density, sample atomic mass, and incoming ion mass. A preferred ion species is Ga+.

Additionally, gas-assisted etching can be used. When a gas is introduced near the surface of the sample during milling, the sputtering yield can increase depending on the chemistry between the gas and the sample. For instance, by injecting a reactive gas into the mill process, the aspect ratio of the ion beam's cutting depth can be dramatically altered such that it is possible to reach the lower metallization line without disturbing the upper layer metallization. This results in less redeposition and more efficient milling. Two typical gasses are iodine and xenon difluoride.

If the sample is non-conductive, a low energy electron flood gun can be used to provide charge neutralization. In this manner, by imaging with positive secondary ions using the positive primary ion beam, even highly insulating samples may be imaged and milled without a conducting surface coating, as would be required in a SEM. This feature is particularly useful for writing surface features directly to the polymeric layer of an optical medium.

Suitable ion guns include the ILG-2, IGPS-2, E/IMG-16, E/IGPS-16, available from Kimball Physics, 311 Kimball Hill Road, Wilton, N.H. 03086-9742 USA. Another suitable ion gun is the IOG 25 Gallium Liquid Metal Ion Gun, available from lonoptika Ltd, Epsilon House, Chilworth Science Park, Southampton, Hampshire SO16 7NS, UK. One skilled in the art will recognize that there are several manufacturers of ion guns that are also suitable for use with the system, including those having larger and smaller spot sizes.

In both the electron beam and ion beam systems, the steering mechanism can use rastering technology to aim the electron beam at the optical medium along the data path. One preferred steering mechanism includes steering coils under control of the controller. Steering coils are copper windings that create magnetic fields that affect the direction of the electron beam. One set of coils creates a magnetic field that moves the electron beam in the X direction, while another set moves the beam in the Y direction. By controlling the voltages in the coils, the electron beam can be positioned at any point on the medium. Because rastering can be performed very quickly, a full data track can be transferred to the optical medium in a fraction of a second.

The raster pattern can be generated by a computer using a standard X-Y grid corresponding to points on the medium. The grid has a density sufficient to allow writing to all necessary points on the medium. The steering mechanism, in turn, directs the electron beam to the points on the medium corresponding to data points on the grid, where a pulse is emitted. A simple raster controller in this type of system can be similar to the controller used in cathode ray tubes (CRTs).

Alternatively, the raster pattern can be set to follow a data track, such as a spiral. The steering coils are energized in such a way that the electron beam moves along the data track, the electron beam pulsing at selected points along the data track. In this type of system, for example, the field emitted by the steering coils in the X and Y directions can follow generally sinusoidal curves where the amplitudes of the curves gradually increase as the beam moves from the inner diameter of the media to its periphery along a spiral data track.

As mentioned above, the surface features are created by electron or ion beam pulses. In most electron or ion guns, including those available from Kimball Physics, the beam may be turned off and on while the gun is running. The way this is accomplished depends on the particular gun design. Often several beam pulsing methods are available for a particular gun.

Pulsing includes stopping and starting the flow of electrons or ions in a fast cycle. This pulsing is usually accomplished by rapidly switching the grid voltage to its cut off potential to stop the beam. The grid provides the first control over the beam and usually can be used to shut off the beam. In an electron gun, if the grid voltage is sufficiently negative with respect to the cathode, it will suppress the emission of the electrons, first from the edge of the cathode and at higher (more negative) voltages from the entire cathode surface. The minimum voltage required to completely shut off the flow of electrons to the target is called the grid cut off. The grid voltage can be controlled by the controller manipulating the power supply; thus, in most guns, the beam can be turned off while the gun is running by setting the grid to the cut off voltage.

The grid voltage can be controlled by several different methods, one being capacitive. Many guns can be equipped with a capacitor-containing device (either a separate pulse junction box or cylinder, or a cable with a box) that receives a signal from an external pulse generator (available from the gun manufacturer). The grid power supply and pulse generator outputs are superimposed to produce the voltage at the grid aperture. The general pattern of the beam pulsing is a square wave with a variable width (time off and time on) and a variable repetition rate. Capacitive pulsing can provide the fastest rise/fall time and shortest pulse length of the various methods. However, the capacitor does not permit long pulses or DC operation. If there is a separate grid lead on the gun, this capacitive pulsing option can be added to most existing gun systems without modification.

A typical pulse length is ˜20-100 nanoseconds, defined as the time the beam is on, measured as the width at 50% of full beam and may include some ringing. The rise/fall time is typically ˜10 nanoseconds measured between 10% and 90% of full beam. Shortening the rise/fall will typically increase ringing. Pulsing performance may also depend on the performance of the user-supplied pulse generator.

Not all guns are designed to be pulsed. For example, a few electron guns have a positive grid in order to extract more electrons, and so these guns do not usually have grid cut off, unless a dual grid supply is ordered. In some high-current electron guns, the optical design, the position of the cathode, does not allow for cut-off with the grid, and so a different option, called blanking, must be used to interrupt the beam instead of pulsing.

Beam blanking deflects the electron beam to one side of the electron gun tube to interrupt the flow of electrons to the target without actually turning off the beam. The voltage applied to the blanker plate in the gun is controlled by a potentiometer on the power supply. Blanking can be used to pulse the final beam current repeatedly on and off in response to a TTL signal input. The blanker voltage required for beam cutoff depends on the gun configuration and on the beam energy, and can be readily determined from the reference materials accompanying the electron gun from the manufacturer.

In both the electron and ion beam methods, the surface features can be made significantly smaller than has heretofore been possible. This is due to the fine detail (e.g., ˜5 nanometer) and sharp edges afforded by electron and ion beam technology. For instance, the surface features can have a length along a data track thereof of less than about 500 nanometers, less than about 200 nanometers, less than about 100 nanometers, and less than about 50 nanometers. In this way, the data storable on a single medium can be greatly improved, limited only by the wavelength of the optical system used. For discs having surface features finer than a DVD, a reader capable of reading finer-than-DVD features is used. For even finer surface features, for example, ultraviolet, microwave and x-ray optical systems may be required to read the data track.

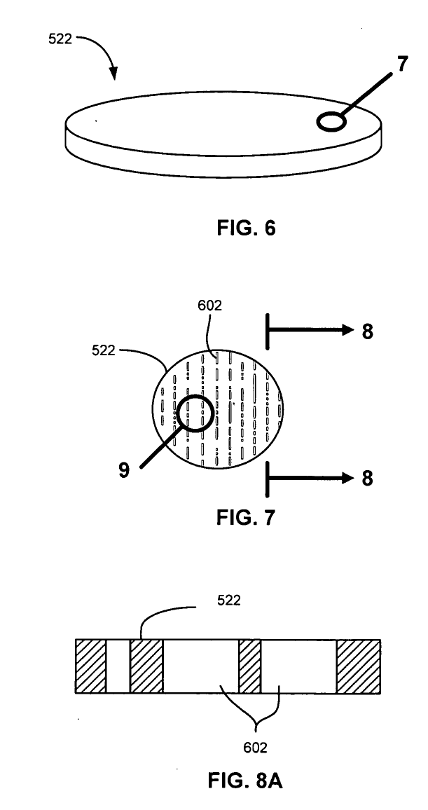

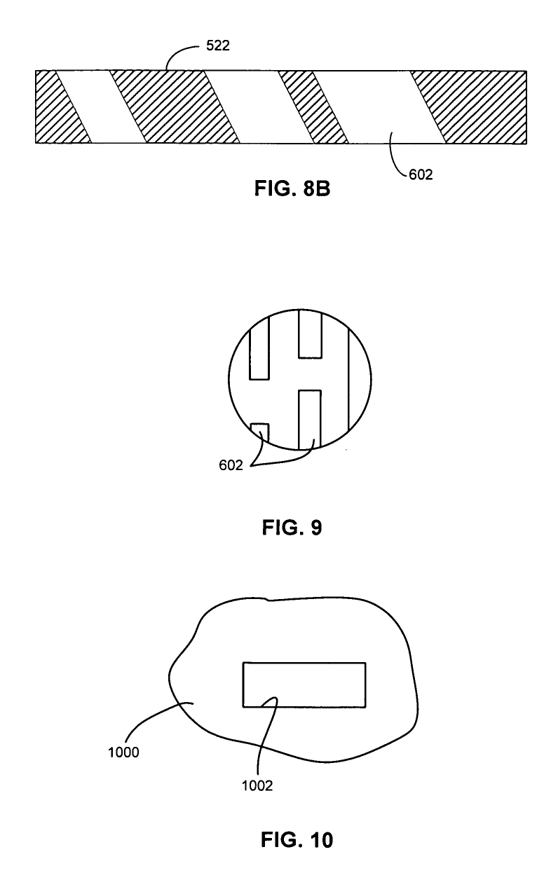

FIGS. 6-9 illustrate a mask 522 for writing data to a medium. As shown, the mask 522 has several apertures 602 arranged in a spiral. The apertures 602 have a standard width taken generally perpendicular to the data track. However, the length and spacing of the apertures 602 along the data track will vary to correspond to the surface features to be created on the medium. As shown in FIG. 8A, the apertures 602 can have sidewalls perpendicular to the plane of the mask 522. Alternatively, as depicted in FIG. 8B, to account for the central location of the ion or electron source, some of the apertures 602 can have angled walls corresponding generally to the electron or ion approach path.

Referring to FIG. 9, it can be seen that the apertures 602 have straight edges and generally perpendicular corners. The resultant surface features created on the media will also have almost perfectly straight edges. FIG. 10 illustrates a surface of a media 1000 formed as above having a surface feature 1002 formed by an electron or ion beam. Unlike standard media, the electron or ion beam-created surface features 1002 have very straight edges and sharp corners. The resultant media has at least 2-3× better resolution, as beveled edges and round corners are not required for release, as is required by a stamper. Further, the degradation of the disc from contact with a stamper is completely avoided. The higher resolution and reduced degradation results in much less jitter than optical media heretofore known. The end result is that the data quality is far superior than has been heretofore known.

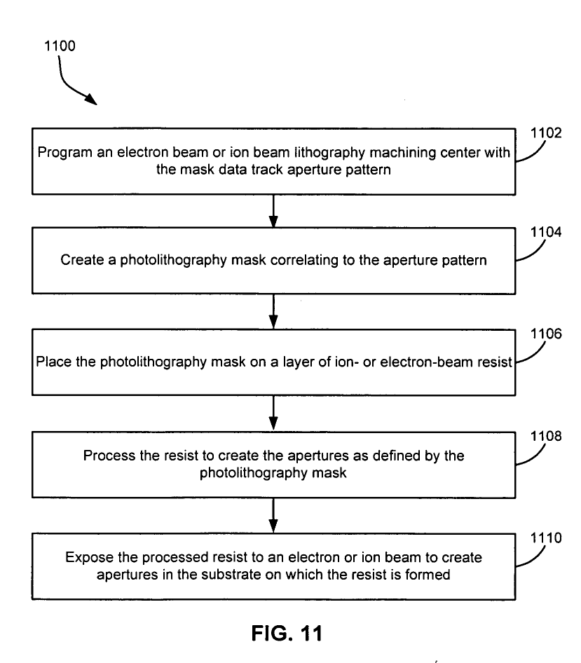

FIG. 11 depicts one process 1100 to create the mask 522. In step 1102, an electron beam or ion beam lithography machining center is programmed with the mask data track aperture pattern. In step 1104, a photolithography mask is created, correlating to the aperture pattern. The photolithography mask is placed on a layer of ion- or electron-beam resist in step 1106 (which will ultimately be the mask used in the ion or electron system). In step 1108, the resist is processed to create the apertures as defined by the photolithography mask. In step 1110, the processed resist can be exposed to an electron or ion beam to create apertures in the substrate on which the resist is formed. Essentially, the features of the patterned resist are transferred to the underlying substrate. Preferably, the substrate is of a soft material, in that it will easily etch away under the ion or electron bombardment without substantial loss of the overlying resist. (As mentioned above, during creation of media, a low energy electron or ion exposure is used, resulting in little loss of the resist. However, it is desirable to maintain a thickness sufficient to protect the integrity of the resist structure.) Any redeposited material in the apertures of the resist can be removed by performing a clean-up exposure.

In a variation, the substrate upon which the resist rests can be of a durable material that is ion or electron mill resistant. The resist is formed to a height high enough to withstand substantial milling. Upon patterning of the resist, the structure is milled to create the apertures in the substrate. The resist will be milled away as well, but due to the increased height, will remain long enough to allow defining of the apertures in the substrate. Then the resist can be removed from the substrate, leaving a mill resistant mask having a long life.

Types of resist and methods to process the resist are presented in more detail below. It should also be pointed out that any electron or ion beam exposure is highly dependant upon processing and substrate, so this information is presented as a starting point. One skilled in the art will understand that he or she may need to perform some experimentation to optimize the processing

TABLE 3
Resist Summary:

| | | | | | | | | Sensitive |
|---|---|---|---|---|---|---|---|---|
| | | | | Etch | | Shelf | Film | To White |
| Resist | Tone | Resolution | Contrast | Resistance | Thickness | Life | Life | Light |
| PMMA | Positive | Very High | Low | Poor | Many | Long | Long | No |
| | | | | | dilutions | @ RT | | |
| P(MMA- | Positive | Low | Low | Poor | Many | Long | Long | No |
| MAA) | | | | | dilutions | @ RT | | |
| NEB-31 | Negative | Very High | High | Good | Several | Long | Short | Yes |
| | | | | | Dilutions | @ RT | | |
| EBR-9 | Positive | Low | Low | Poor | Single | Long | Long | No |
| | | | | | Dilution | @ RT | | |
| ZEP | Positive | Very High | High | Good | Several | Long | Short | Yes |
| | | | | | Dilutions | @ RT | | |
| UV-5 | Positive | High | High | Good | Several | Long | Short | Yes |
| | | | | | Dilutions | @ RT | | |

PMMA Resist

Poly(methyl methacrylate) (PMMA) is far and away the most popular e-beam resist, offering extremely high-resolution, ease of handling, excellent film characteristics, and wide process latitude. One of PMMA's primary attributes is its simplicity: PMMA polymer dissolved in a solvent (Anisole safe solvent). Exposure causes scission of the polymer chains. The exposed (lighter molecular weight) resist is then developed in a solvent developer.

Characteristics:
Positive tone
Very high resolution, low contrast
Poor dry etch resistance
Several dilutions available, allowing a wide range of resist thickness
No shelf life or film life issues
Not sensitive to white light

Developer mixtures can be adjusted to control contrast and profile

TABLE 4
Basic Processing:

| | |
|---|---|
| Surface | In general, no surface preparation (aside from normal |
| Preparation | cleaning) is necessary. Excellent adhesion to most surfaces. |
| Spin | Speed 1000-5000 rpm, 60 sec. (100-1000 nm) |
| Pre-bake | 170° C. hotplate, 15 min., non-critical. Must be 150 < T < |
| | 200 degrees, for at least 10 minutes. May also be oven |
| | baked at 170° C. for 1 hour. |
| Expose | Dose around 170 uC/cm2 at 40 kV. |
| Develop | 1:1 MIBK:IPA, 1-2 minutes. (1:3 MIBK:IPA is an option, |
| | offering higher resolution, but lower sensitivity i.e. higher |
| | dose.) |
| Rinse | With IPA |
| Dry | By spinning or dry N2 |
| Post-Bake | Not normally necessary. Flow can begin as low as 120° C. |
| | Does not seem to noticeably improve adhesion or etch |
| | resistance. |
| Descum | Light! (But necessary for good liftoff and clean etching.) |
| | PMMA etches very fast in oxygen. In an oxygen RIE, |
| | descum times are short, around 5 sec. In a barrel asher, |
| | times can be around 1 minute, but beware! Do not |
| | preheat the PMMA. Removal rates increase dramatically |
| | with temperature. |
| Stripping | Most solvents, including methylene chloride and acetone |
| | will strip PMMA, as will NMP (Remover 1165). It is |
| | removed very well by strong bases (KOH), and by acid |
| | normally hostile to organics, such as NanoStrip. Oxygen |
| | plasmas etch PMMA very well. |

P(MMA-MAA) Copolymer Resist

Copolymer, P(MMA-MAA), offers a higher sensitivity than PMMA, (thus can be exposed at a lower dose, thus faster), with a tradeoff in contrast. It is most useful in bi-level resists with PMMA, to produce undercut profiles useful in liftoff processing.

Characteristics:
Positive tone
Low resolution, low contrast
Poor dry etch resistance
Several dilutions available, allowing a wide range of resist thickness
No shelf life or film life issues
Not sensitive to white light

Developer mixtures can be adjusted to control contrast and profile

TABLE 5
Basic Processing:

| | |
|---|---|
| Surface | In general, no surface preparation (aside from normal |
| Preparation | cleaning) is necessary. Excellent adhesion to most surfaces. |
| Spin | Speed 1000-5000 rpm, 60 sec. (100-1000 nm) |
| Pre-bake | 170° C. hotplate for 15 min., non-critical. Must be 150 < |
| | T < 200 degrees, for at least 10 minutes. May also be oven |
| | baked at 170° C. for 1 hour. |
| Expose | Dose around 70 uC/cm2 at 40 kV. |
| Develop | 1:1 MIBK:IPA, 1-2 minutes. (1:3 MIBK:IPA is an option, |
| | offering higher contrast, but lower sensitivity ie. higher |
| | dose.) |
| Rinse | With IPA |
| Dry | By spinning or dry N2 |
| Post-Bake | Not normally necessary. Flow can begin as low as 120° C. |
| | Does not seem to noticeably improve adhesion or etch |
| | resistance. |
| Descum | Light! (But necessary for good liftoff and clean etching.) |
| | PMMA etches very fast in oxygen. In an oxygen RIE, |
| | descum times are short, around 5 sec. In a barrel asher, |
| | times can be around 1 minute, but beware! Do not |
| | preheat the PMMA. Removal rates increase dramatically |
| | with temperature. |
| Stripping | Most solvents, including methylene chloride and acetone |
| | will strip PMMA, as will NMP (Remover 1165). It is |
| | removed very well by strong bases (KOH), and by acid |
| | normally hostile to organics, such as NanoStrip. Oxygen |
| | plasmas etch PMMA very well. |

NEB-31 Resist

High resolution chemically amplified negative resist with high sensitivity and contrast

Characteristics:
Negative tone
Very high resolution (40 nm demonstrated), high contrast
Dry etch resistance comparable to most photo resists
Several dilutions available, allowing a wide range of resist thickness
No shelf life issues for resist solution if stored at room temperature
Film life issues

Sensitive to white light

TABLE 6
Basic Processing:

| | |
|---|---|
| Surface | In general, no surface preparation (aside from normal |
| Preparation | cleaning) is necessary. Excellent adhesion to most surfaces. |
| | For metals, particularly noble metals, dehydration bake @ |
| | 170° C. for 15 minutes and apply P2 liquid prime or HMDS |
| | vapor prime. |
| Spin | Speed 1000-5000 rpm, 60 sec. (100-1000 nm) Coated |
| | samples may be stored up to 2 weeks prior to exposure. |
| Pre-bake | 110° C. vacuum hotplate (Brewer) for 2 minutes. |
| Expose | Dose around 20 uC/cm2 at 40 kV; 10% of PMMA dose |
| | requirement. |
| Post-Bake | 95° C. vacuum hotplate (Brewer) for 4 minutes - PEB |
| | should occur within 24 hours of exposure. |
| Develop | MF-321; 10 seconds/100 nm resist thickness. |
| Rinse | DI water |
| Dry | By spinning or dry N2 |
| Descum | RIE conditions: 30 sccm O2, 30 mTorr total pressure, 90 W |
| | (0.25 W/cm2), 5 sec. or: Descum in barrel etcher, 0.6 Torr |
| | of oxygen, 150 W, 1 min. |
| Stripping | Remover 1165 overnight @ RT, or 1165 @ 70°(bath in PG |
| | room) for ˜30 minutes. O2 plasma etches NEB very well. |

Toray EBR-9 Resist

EBR-9 is a fast, medium resolution positive resist used mostly for mask masking.

Characteristics:
Positive tone
500 nm best resolution
Poor dry etch resistance
For masks, normally applied at 3000 rpm/320 nm thick
Long shelf life for resist solution
No film life issues
Not sensitive to white light

Developer mixtures can be adjusted to control contrast and profile

TABLE 7
Basic Processing:

| | |
|---|---|
| Surface | In general, no surface preparation (aside from normal |
| Preparation | cleaning) is necessary. Excellent adhesion to most surfaces. |
| Spin | Speed 3000 rpm, 60 sec. (320 nm) |
| Pre-bake | 170° C. oven, 1 hr. Non-critical. Must be 170 < T < 180 |
| | degrees, for at least 30 minutes. May also be hot-plate |
| | baked. |
| Expose | Dose around 17 uC/cm2 at 40 kV. |
| Develop | 3:1 MIBK:IPA, 4 minutes. (Note that this is not 1:3 |
| | MIBK:IPA !) |
| Rinse | With IPA |
| Dry | By spinning or dry N2 |
| Descum | RIE conditions: 30 sccm O2, 30 mTorr total pressure, 90 W |
| | (0.25 W/cm2), 5 sec. or: Descum in barrel etcher, 0.6 Torr |
| | of oxygen, 150 W, 1 min. |
| (Cr Etch for | Etch with Transene Cr etchant, ˜1.5 min |
| mask plate) | |
| Stripping | Most solvents, including methylene chloride and acetone |
| | will strip EBR-9, as will NMP (Remover 1165). It is |
| | removed very well by strong bases (KOH), and by acid |
| | normally hostile to organics, such as NanoStrip. RIE in |
| | oxygen. Do not use a barrel etcher. RIE conditions: 30 |
| | sccm O2, 30 mTorr total pressure, 90 W (0.25 |
| | W/cm2), 3 min. |

ZEP Series

The ZEP series encompasses positive-tone, chemically amplified electron beam resists with high resolution and excellent dry-etching resistance for device fabrication. The series is ideally suited to the creation of photo masks and X-ray masks as well as ultra-fine processing.

Characteristics:
Positive tone
Resolution at least 20 nm
Dry etch resistance comparable to most photo resists
Film Life

Wide process margin

TABLE 8
Basic Processing:

| | |
|---|---|
| Surface | In general, no surface preparation (aside from normal |
| Preparation | cleaning) is necessary. Excellent adhesion to most surfaces. |
| Spin | Speed 1000-5000 rpm, 60 sec. (100-1000 nm) |
| Pre-bake | 170° C. hotplate, 2 minutes |
| Expose | 10-20% the dose requirement of PMMA |
| Develop | Solvent develop depending on resist |
| Rinse | With IPA |
| Dry | By spinning or dry N2 |
| Post-Bake | Not normally necessary. |
| Descum | RIE conditions: 30 sccm O2, 30 mTorr total pressure, 90 W |
| | (0.25 W/cm2), 5 sec. or: Descum in barrel etcher, 0.6 Torr |
| | of oxygen, 150 W, 1 min. |
| Stripping | Remover 1165 overnight @ RT, or 1165 @ 70°(bath in PG |
| | room) for (30 minutes. O2 plasma etches NEB very well. |
| | Remove residual resist with oxygen RIE: 30 sccm O2, |
| | 30 mTorr total pressure, 0.25 W/cm2, 5 min. |

UV-5 Photoresist

High resolution chemically amplified DUV positive resist with high sensitivity and contrast

Characteristics:
Positive tone
Resolution at least 150 nm
Excellent dry etch resistance
Several dilutions available, allowing a wide range of resist thickness
No shelf life issues for resist stored at room temperature
Film life issues
Sensitive to white light

Wide process margin

TABLE 9
Basic Processing:

| | |
|---|---|
| Surface | Plasma clean Si wafer in Branson barrel etcher; |
| Preparation | Process 3-1000 W O2 for 3 minutes followed by |
| | HMDS P-20 liquid prime. Cover wafer with primer puddle |
| | and leave for 1 minute prior to spinning at any speed |
| | for >30 seconds. Proceed to spin on resist immediately. |
| Spin | Speed 1000-5000 rpm, 60 sec. (100-1000 nm) |
| Pre-bake | 130° C. vacuum hotplate (Brewer), 60 seconds. Exposure |
| | should occur within 24 hours of pre-bake. |
| Expose | Dose 15-25 uC/cm2 at 40 kV; about 10% of PMMA dose. |
| Post-Bake | 130° C. vacuum hotplate (Brewer), 60 seconds. PEB should |
| | occur within 90 minutes of exposure. |
| Develop | CD-26 for 45-90 seconds. |
| Rinse | DI water |
| Dry | By spinning or dry N2 |
| Descum | RIE conditions: 30 sccm O2, 30 mTorr total pressure, 90 W |
| | (0.25 W/cm2, 5 sec. or: Descum in barrel etcher, 0.6 Torr |
| | of oxygen, 150 W, 1 min. |
| Stripping | Remover 1165 overnight @ RT, or 1165 @ 70°(bath in PG |
| | room) for ˜30 minutes. O2 plasma etches NEB very well. |

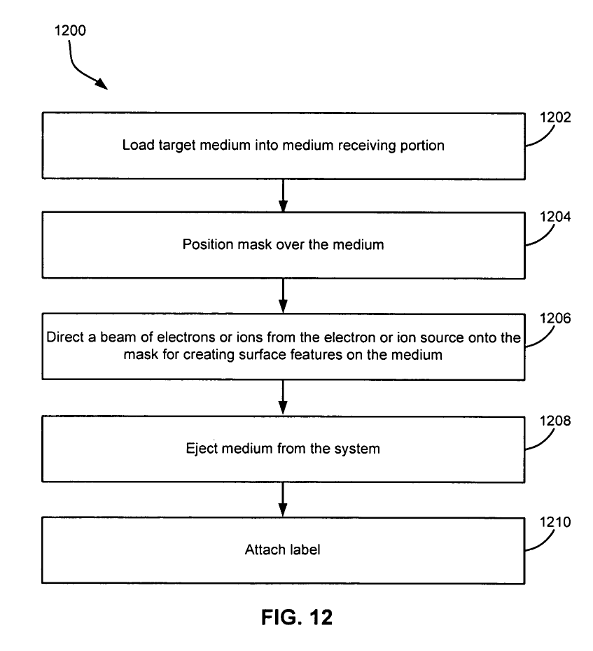

FIG. 12 depicts a method 1200 for writing data to a medium (e.g., CD, DVD) using electron or ion beam technology. In operation 1202, the target disc is loaded into the medium receiving portion either manually or by an automated system. The medium receiving portion preferably holds the target disc in a fixed position so that movement is eliminated. The data area faces the electron gun. In operation 1204, the mask is positioned over the medium. In operation 1206, under control of the controller, a beam of electrons or ions from the electron or ion gun is directed onto the mask for creating surface features on the medium. A diffuse electron or ion beam is directed towards the mask in a controlled manner to create the surface features on the medium when the electrons or ions pass through the apertures in the mask and onto the medium and material is milled therefrom. The power level of the electron or ion beam is preferably selected to create pits of a desired depth in the medium, while minimizing wear on the resist. The resultant surface features represent data in a data track. The resulting data track can be a spiral pattern starting from the inner diameter of the disc. The power and duration of the electron or ion beam are set such that they will create optically discernable features on the reflective layer. For a CD, the data points are about 0.5 microns (500 nanometers) wide, and a minimum of 0.83 (830 nanometers) microns long. The track spacing is about 6 microns (6000 nanometers). In a DVD, the damaged sections of the reflective layer that make up the data track are each about 320 nanometers wide and a minimum of 400 nanometers long. The track spacing is about 740 nanometers.

In operation 1208, the medium is ejected from the system. In operation 1210, a label is then printed onto the medium using a printing device known in the art, or affixed as an adhesive layer. In this way, the damaged area of the medium is covered and is nonapparent to the end user. The side of the label adjacent the medium is preferably nonreflective so as not to reflect the reader's laser during playback. Also note that a protective layer can optionally be added prior to affixing the label.

In a variation on the above, the beam of electrons or ions is swept across the mask in a controlled manner, such as in a serpentine path, back and forth along parallel paths, etc. In a further variation, instead of sweeping the beam across the mask, areas of the mask are sequentially exposed by a flood of electrons or ions. In either of these embodiments, a beam blanker, pulse generator, on/off control, etc. can be used to control the duration of the exposure.

As mentioned above, a CD and DVD typically comprises a clear polycarbonate plastic underlayer, a thin, reflective aluminum layer sputtered onto the polycarbonate, and a thin protective layer, e.g., acrylic, lacquer, etc. sprayed over the aluminum to protect it. In one method, the target disc as loaded into the system comprises polycarbonate, a reflective layer, and acrylic backing. The acrylic backing faces the mask and the ion or electron gun. The power of the ion beam is set such that it will pierce the backing layer and create optically discernable features on the reflective layer so that the reader will only detect reflections from the nonexposed parts of the reflective layer, thereby creating surface features along the data track.

In another variation, the beam of ions or electrons is directed through the mask and onto the polycarbonate layer for creating surface features on the disc, the surface features representing data in a data track. The power of the ion beam is set such that it creates pits in the polycarbonate layer. For a CD, the pits are set at about 125 nanometers deep. For a DVD, the pits are set at about 120 nanometers deep. A reflective layer is then sputtered onto the disc. An acrylic backing and label can also be added.

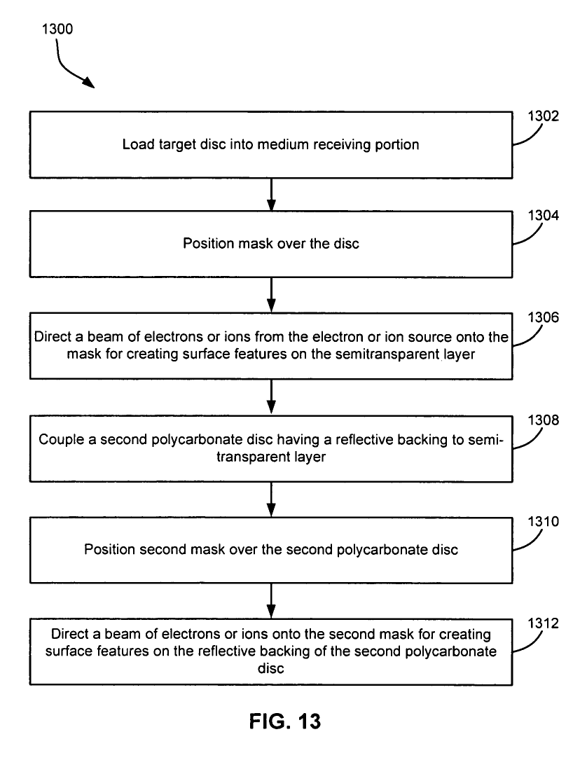

FIG. 13 depicts a method 1300 for writing data to a single sided, double layer (per side) DVD. In this method, a first substantially transparent polycarbonate layer having a semi-transparent layer, preferably of gold, is loaded into the medium receiving portion. Note operation 1302. This is the outer readable layer. The semi-transparent layer faces the mask and the gun. In operation 1304, the mask is positioned over the disc. In operation 1306, under control of the controller, electrons or ions from the electron or ion gun are directed through the mask and onto the semi-transparent layer for creating surface features on the disc, the surface features representing data in a data track that is readable as the outer data track. In operation 1308, a second polycarbonate disc having a reflective backing is coupled to the semi-transparent layer. In operation 1310, a second mask is positioned over the second polycarbonate disc. The reflective backing faces the mask and the gun. In operation 1312, under control of the controller, ions or electrons are directed onto the second mask and therethrough to the reflective layer for creating surface features on the disc, the surface features representing data in a data track that is readable as the inner data track. Then additional steps, such as adding an acrylic backing and label can be performed.

This method 1300 has the advantage that the disc does not move, and the gun does not move. The second layer is created in situ after coupling, so the inner and outer readable layers are inherently aligned perfectly every time.

The process can be repeated to create two additional data layers which can be coupled to the first and second polycarbonate discs, thereby creating a dual side, double layer DVD. In fact, the process can be repeated to create as many layers as desired.

Likewise, the method where the transparent layers are damaged by the ion beam can be adapted to create multi-level optical media, as will be apparent to one skilled in the art. In this situation, the transparent layer of the outer readable layer is first written to, and a semi-transparent layer is sputtered onto it. A second transparent layer (inner readable layer) is coupled to the semi-transparent layer and data written thereto. A reflective layer is then sputtered onto the second transparent layer followed by labeling or addition of other layers.

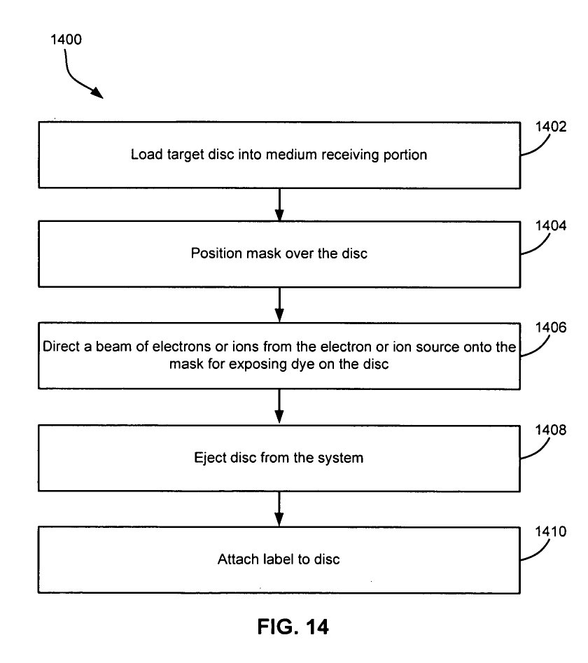

FIG. 14 depicts a method 1400 for writing data to a recordable disc, such as a commercially available recordable CD or DVD. In this method, the disc comprises a substantially transparent layer, a dye layer, and a reflective layer as loaded into the medium receiving portion, the reflective layer facing the gun. Note operation 1402. In operation 1404, the mask is positioned over the disc. In operation 1406, under control of the controller, a beam of ions or electrons from the ion or electron gun are directed onto the disc for exposing the dye in the dye layer. The exposed dye darkens, thereby creating surface features representing data in a data track. The power of the ion beam is preferably set such that it pierces the reflective layer and exposes the dye, but does not significantly damage the underlying transparent layer. In operation 1408, the disc is ejected from the system. In operation 1410, a label is then printed onto the acrylic using a printing device known in the art, or affixed as an adhesive layer.

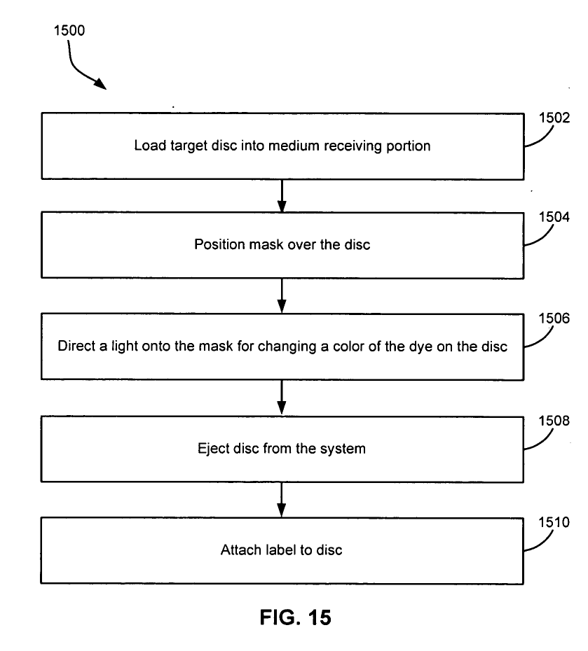

FIG. 15 depicts a method 1500 for writing data to a recordable disc, such as a commercially available recordable CD or DVD. In this method, the disc comprises a substantially transparent layer, a dye layer, and a reflective layer as loaded into the medium receiving portion, the substantially transparent layer facing the gun. Note operation 1502. In operation 1504, the mask is positioned over the disc. In operation 1506, under control of a controller, energy, e.g., light, capable of changing the color of the dye is directed onto the disc for exposing the dye in the dye layer. The light can be a diffuse beam, a focused beam, a sweeping laser, etc. The exposed dye darkens, thereby creating surface features representing data in a data track. In operation 1508, the disc is ejected from the system. In operation 1510, a label is then printed onto the acrylic using a printing device known in the art, or affixed as an adhesive layer.

These methods 1400, 1500 can also be used to write to rewritable discs, e.g., CD-RW and DVD+RW. In that case, the power of the ion beam is set to heat areas of the phase-change material above the melting temperature (500-700° C.), so all the atoms in this area can move rapidly in the liquid state. Then, if cooled sufficiently quickly, the random liquid state is “frozen-in” and the so-called amorphous state is obtained. The amorphous version of the material shrinks, leaving a pit where the data point was written by the ion beam, resulting in a recognizable CD or DVD surface.

One skilled in the art will appreciate that the various operations of the methods described above can be combined to create additional methods for writing data to optical media, such additional method being considered within the scope of the present invention. One skilled in the art will also appreciate that the methods can be adapted with software instructions to write to types of media other than disc shaped media.

In any of these methods, the surface features can be made significantly smaller than has heretofore been possible, even using commercially available media. This is due to the fine detail (e.g., ˜5 nanometer) and sharp edges afforded by ion beam technology.

For instance, the surface features can have a length along a data track thereof of less than about 500 nanometers, less than about 200 nanometers, less than about 100 nanometers, and less than about 50 nanometers. In this way, the data storable on a single medium can be greatly improved, limited only by the wavelength of the optical system used. For discs having surface features finer than a DVD, a reader capable of reading finer-than-DVD features is used. For even finer surface features, for example, ultraviolet, microwave and x-ray optical systems may be required.

Additionally, the speed at which media can be produced is dramatically increased over heretofore known methods such as glass mastering.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for writing data to an optical medium, comprising:
positioning a mask over a medium, the mask having apertures therein;
exposing the mask and medium to an electron source, the electrons passing through the apertures in the mask for creating surface features on the medium, the surface features representing data.

2. The method as recited in claim 1, wherein the optical medium is a disc.

3. The method as recited in claim 2, wherein the surface features are arranged in a generally spiral shape.

4. The method as recited in claim 2, wherein the optical medium is readable by a consumer-grade compact disc (CD) player.

5. The method as recited in claim 2, wherein the optical medium is readable by a consumer-grade digital video disc (DVD) player.

6. The method as recited in claim 1, wherein the optical medium is readable by a reader capable of reading surface features finer than a consumer-grade digital video disc (DVD) player.

7. The method as recited in claim 1, wherein the medium is a commercially available compact disc.

8. The method as recited in claim 1, wherein the medium is a commercially available digital video disc.

9. The method as recited in claim 1, wherein the medium is a commercially available writable compact disc.

10. The method as recited in claim 1, wherein the medium is a commercially available writable digital video disc.

11. The method as recited in claim 1, wherein the medium is a commercially available writable optical medium.

12. The method as recited in claim 1, wherein the medium comprises a substantially transparent layer and a reflective layer, the electrons damaging the reflective layer.

13. The method as recited in claim 1, wherein the medium comprises a substantially transparent layer and a reflective layer, the electrons creating pits in the substantially transparent layer, the reflective layer being added after the surface features are created.

14. The method as recited in claim 1, wherein the medium comprises a reflective layer, and a dye layer being substantially transparent in an unexposed state, the electrons creating darkened portions of the dye layer.

15. The method as recited in claim 1, wherein the surface features have a length along a data track thereof of less than about 500 nanometers.

16. The method as recited in claim 1, wherein the surface features have a length along a data track thereof of less than about 200 nanometers.

17. The method as recited in claim 1, wherein the surface features have a length along a data track thereof of less than about 100 nanometers.

18. The method as recited in claim 1, wherein the surface features are created on at least two layers of the optical medium.

19. The method as recited in claim 1, wherein the data is written to the optical medium in less than about one second.

20. The method as recited in claim 1, wherein the electron source emits a diffuse beam of electrons.

21. The method as recited in claim 1, wherein the electrons emitted by the electron source are swept across the mask.

22. The method as recited in claim 1, wherein different portions of the mask are sequentially exposed to the electrons emitted by the electron source.

23. A method for writing data to an optical medium, comprising:
positioning a mask over a medium, the mask having apertures therein;
exposing the mask and medium to an ion source, the ions passing through the apertures in the mask for creating surface features on the medium, the surface features representing data.

24. The method as recited in claim 23, wherein the optical medium is a disc.

25. The method as recited in claim 24, wherein the surface features are arranged in a generally spiral shape.

26. The method as recited in claim 24, wherein the optical medium is readable by a consumer-grade compact disc (CD) player.

27. The method as recited in claim 24, wherein the optical medium is readable by a consumer-grade digital video disc (DVD) player.

28. The method as recited in claim 23, wherein the optical medium is readable by a reader capable of reading surface features finer than a consumer-grade digital video disc (DVD) player.

29. The method as recited in claim 23, wherein the medium is a commercially available compact disc.

30. The method as recited in claim 23, wherein the medium is a commercially available digital video disc.

31. The method as recited in claim 23, wherein the medium is a commercially available writable compact disc.

32. The method as recited in claim 23, wherein the medium is a commercially available writable digital video disc.

33. The method as recited in claim 23, wherein the medium is a commercially available writable optical medium.

34. The method as recited in claim 23, wherein the medium comprises a substantially transparent layer and a reflective layer, the ions damaging the reflective layer.

35. The method as recited in claim 23, wherein the medium comprises a substantially transparent layer and a reflective layer, the ions creating pits in the substantially transparent layer, the reflective layer being added after the surface features are created.

36. The method as recited in claim 23, wherein the medium comprises a reflective layer, and a dye layer being substantially transparent in an unexposed state, the ions creating darkened portions of the dye layer.

37. The method as recited in claim 23, wherein the surface features have a length along a data track thereof of less than about 500 nanometers.

38. The method as recited in claim 23, wherein the surface features have a length along a data track thereof of less than about 200 nanometers.

39. The method as recited in claim 23, wherein the surface features have a length along a data track thereof of less than about 100 nanometers.

40. The method as recited in claim 23, wherein the surface features are created on at least two layers of the optical medium.

41. The method as recited in claim 23, wherein the data is written to the optical medium in less than about one second.

42. The method as recited in claim 23, wherein the ion source emits a diffuse beam of ions.

43. The method as recited in claim 23, wherein the ions emitted by the ion source are swept across the mask.

44. The method as recited in claim 23, wherein different portions of the mask are sequentially exposed to the ions emitted by the ion source.

45. A method for writing data to a dye-based optical medium, comprising:
positioning a mask over a dye-based medium, the mask having apertures therein;
directing energy capable of changing a color of the dye onto the mask, the energy passing through the apertures in the mask and onto the medium for creating surface features of different colors in the dye layer, the surface features representing data.

46. The method as recited in claim 45, wherein the optical medium is readable by a consumer-grade compact disc (CD) player.

47. The method as recited in claim 45, wherein the optical medium is readable by a consumer-grade digital video disc (DVD) player.

48. The method as recited in claim 45, wherein the medium is a commercially available writable compact disc.

49. The method as recited in claim 45, wherein the medium is a commercially available writable digital video disc.

50. The method as recited in claim 45, wherein the medium is a commercially available writable optical medium.

51. The method as recited in claim 45, wherein the medium comprises a reflective layer, and a dye layer being substantially transparent in an unexposed state, the ion pulses creating darkened portions of the dye layer.

52. The method as recited in claim 45, wherein the surface features are created on at least two layers of the optical medium.

53. The method as recited in claim 45, wherein the data is written to the optical medium in less than about one second.

54. A system for writing data to an optical medium, comprising:
a medium receiving portion for holding an optical medium;
an electron source for emitting electrons at the optical medium on the medium receiving portion; and
a mask having apertures therein, the electrons passing through the apertures in the mask for creating surface features on the medium, the surface features representing data.

55. The system as recited in claim 54, wherein the optical medium is a disc.

56. The system as recited in claim 55, wherein the surface features are arranged in a generally spiral shape.

57. The system as recited in claim 55, wherein the optical medium is readable by a consumer-grade compact disc (CD) player.

58. The system as recited in claim 55, wherein the optical medium is readable by a consumer-grade digital video disc (DVD) player.

59. The system as recited in claim 54, wherein the medium comprises a substantially transparent layer and a reflective layer, the electrons damaging the reflective layer.

60. The system as recited in claim 54, wherein the medium comprises a substantially transparent layer and a reflective layer, the electrons creating pits in the substantially transparent layer, the reflective layer being added after the surface features are created.

61. The system as recited in claim 54, wherein the medium comprises a reflective layer, and a dye layer being substantially transparent in an unexposed state, the electrons creating darkened portions of the dye layer.

62. A system for writing data to an optical medium, comprising:
a medium receiving portion for holding an optical medium;
an ion source for emitting ions at the optical medium on the medium receiving portion; and
a mask having apertures therein, the ions passing through the apertures in the mask for creating surface features on the medium, the surface features representing data.

63. The system as recited in claim 62, wherein the optical medium is a disc.

64. The system as recited in claim 63, wherein the surface features are arranged in a generally spiral shape.

65. The system as recited in claim 63, wherein the optical medium is readable by a consumer-grade compact disc (CD) player.

66. The system as recited in claim 63, wherein the optical medium is readable by a consumer-grade digital video disc (DVD) player.

67. The system as recited in claim 62, wherein the medium comprises a substantially transparent layer and a reflective layer, the ions damaging the reflective layer.

68. The system as recited in claim 62, wherein the medium comprises a substantially transparent layer and a reflective layer, the ions creating pits in the substantially transparent layer, the reflective layer being added after the surface features are created.

69. The system as recited in claim 62, wherein the medium comprises a reflective layer, and a dye layer being substantially transparent in an unexposed state, the ions creating darkened portions of the dye layer.

70. An optical medium, comprising:
an underlayer; and
a reflective layer,
wherein at least one of the underlayer and the surface layer has surface features thereon representing data, the surface features having been formed by directing electrons or ions from an electron or ion source through apertures in a mask and onto at least one of the underlayer and the reflective layer in a controlled pattern for creating the surface features.

71. The optical medium as recited in claim 70, wherein the optical medium is a disc.

72. The optical medium as recited in claim 71, wherein the pattern has a generally spiral shape.

73. The optical medium as recited in claim 71, wherein the optical medium is readable by a consumer-grade compact disc (CD) player.

74. The optical medium as recited in claim 71, wherein the optical medium is readable by a consumer-grade digital video disc (DVD) player.

75. The optical medium as recited in claim 70, wherein the optical medium is readable by a reader capable of reading surface features finer than a consumer-grade digital video disc (DVD) player.

76. The optical medium as recited in claim 70, wherein the optical medium is a commercially available compact disc.

77. The optical medium as recited in claim 70, wherein the optical medium is a commercially available digital video disc.

78. The optical medium as recited in claim 70, wherein the optical medium is a commercially available writable compact disc.

79. The optical medium as recited in claim 70, wherein the medium is a commercially available writable digital video disc.

80. The optical medium as recited in claim 70, wherein the optical medium is a commercially available writable optical medium.

81. The optical medium as recited in claim 70, wherein the electrons or ions modify the underlayer.

82. The optical medium as recited in claim 70, wherein the electrons or ions modify the reflective layer.

83. The optical medium as recited in claim 70, wherein the electrons or ions have created pits in the underlayer, the reflective layer having been added after the surface features are created.

84. The optical medium as recited in claim 70, wherein the underlayer is a dye layer being substantially transparent in an unexposed state, the electron pulses creating darkened portions of the dye layer.

85. The optical medium as recited in claim 70, wherein the underlayer is a dye layer being substantially nontransparent in an unexposed state, the electrons or ions creating substantially transparent portions of the dye layer.

86. The optical medium as recited in claim 70, further comprising multiple underlayers and multiple reflective layers.

87. The optical medium as recited in claim 86, wherein the multiple underlayers and multiple reflective layers are present on a same readable side of the optical medium.

88. The optical medium as recited in claim 86, wherein the underlayers are positioned on opposite sides of the optical medium, wherein the reflective layers are positioned on opposite sides of the optical medium.

89. The optical medium as recited in claim 70, wherein the surface features have a length along a data track thereof of less than about 500 nanometers.

90. The optical medium as recited in claim 70, wherein the surface features have a length along a data track thereof of less than about 200 nanometers.

91. The optical medium as recited in claim 70, wherein the surface features have a length along a data track thereof of less than about 100 nanometers.

92. The optical medium as recited in claim 70, wherein the surface features are created on at least two layers of the optical medium.

93. The optical medium as recited in claim 70, wherein the data includes audio data.

94. The optical medium as recited in claim 70, wherein the data includes video data.

95. The optical medium as recited in claim 70, wherein the data includes software.

96. An optical medium, comprising:
a dye layer being substantially transparent in an unexposed state; and
a reflective layer,
wherein darkened portions have been created in the dye layer by directing electrons or ions from an electron or ion source through apertures in a mask and onto the dye layer.

97. An optical medium, comprising:
a dye layer being substantially transparent in an unexposed state; and
a reflective layer,
wherein darkened portions have been created in the dye layer by directing energy through apertures in a mask and onto the dye layer.
